(19) United States
(12) Patent Application Publication
(10) Pub. No.: US 2011/0255049 A1
(43) Pub. Date: Oct. 20, 2011

(54) Eye Glass Attachable Hearing Protection

(76) Inventor: Joseph Corona, Baden, PA (US)

(21) Appl. No.: 13/083,579

(22) Filed: Apr. 10, 2011

Related U.S. Application Data
(60) Provisional application No. 61/324,399, filed on Apr. 15, 2010.

(51) Int. Cl. G02C 5/14

(52) U.S. Cl. 351/123

(57) ABSTRACT

A hearing protection device capable of attachment to a temple support bar of any pair of eye or safety glasses. The device comprises an elongated bracket with internal clips for attachment means, along with a hingedly rotating extension arm with attached earplug for providing hearing protection in noisy environments. The rotating assembly allows the earplug to be inserted into the practitioner's ear or conveniently pulled away and stowed against the user's head, away from moving machinery which would otherwise create an entanglement concern. The device provides efficient removal and storage of earplugs in conjunction with eye protection or eye glasses

### CROSS REFERENCE TO RELATED APPLICATION

This application claims the benefit of U.S. Provisional Application No. 61/324,399 filed on Apr. 15, 2010, entitled “Hearing Protection.”

### BACKGROUND OF THE INVENTION

1. Field of the Invention

The present invention relates to hearing and eye protection devices. More specifically, the present invention relates to a hingedly rotating earplug assembly attachable to eye or safety glasses.

2. Background and Description of the Prior Art

In many industrial plants and factories, workers are required to wear safety glasses and/or earplugs in order to protect their eyes from flying objects and their ears from excessive noise levels. One particularly common and very effective form of earplug consists of a baffled cone-shaped member having a cavity or recess in its posterior end. This cavity allows attachment of the earplug to different devices, most typically to a cord or string. Such earplug and cord assemblies commonly dangle from the user's neck, causing annoyance and creating a potential risk of injury if the user is in proximity to moving machinery that could entangle with the cord.

In many work environments, safety glasses and earplugs are not always readily available or kept in a colocated location. It is also easy to misplace or lose a set of hearing or eye protection in these environments. To ensure all workers comply with regulations and protect their ears and eyes, a device is required to that combines each protection device, and provides an improved means to store and use the devices.

The present invention is an eye glass attachable device that allows for the use or storage of earplugs while the practitioner is wearing a set of eye or safety glasses. The device provides attachment to eye or safety glasses in a hinged manner to eliminate the common remedies to securing ear protection to a user. The attachment and coloation of the hearing protection allows for their consistent availability, which allows quick insertion or removal. The device further prevents the earplugs from falling on the ground or other contaminated surface by suspending the earplugs next to the eye or safety glasses when not in use. It also eliminates the need for a device that encircles the head, which is common in the art for string-type earplug assemblies.

Earplugs and devices that attach to eye or safety glasses are prevalent in the prior art. Patents have been granted, as well as applications published, for several devices that attempt to address the problems of earplug availability and cleanliness. However, the prior art fails to provide a device fully capable of conveniently assisting with the insertion and removal of ear plugs while preventing their loss or contamination. Further, the prior art fails to provide a device that prevents the associated earplug cords from becoming entangled in machinery or other devices in a factory work environment.

There are numerous devices that provide a cord or other string-type method of attachment. Pyle U.S. Pat. No. 5,475,449 is directed to a string-type device, which removably secures a standard set of earplugs to a pair of eyeglasses. In addition to the Pyle invention's string-type nature, modification of the eyeglass to include a loop portion on the temple support bar is required, through which the invention must passed. Rhoad U.S. Pat. No. 5,806,526 is directed to a pair of earplugs that are removably attached to eye or safety glasses by a cord. Additionally, the earplugs, which are preferably made of foam or some other deformable material, can attach to each other to form a continuous strap for holding or hanging a pair of glasses.

Fleming U.S. Pat. No. 6,082,855 is directed to an attachment for safety eyeglasses that includes a mount for an eyeglass temple support bar, an earplug that can fit into the ear canal to block noise, and a string-type coupling that connects the mount to the earplug. The mount includes a tube of elastomeric material that can be stretched over the temple bar to fix its position and prevent “jiggling”. The coupling includes a wire of resilient plastic that is wound into a tight helix, which allows it to be stored between the rear of the outer ear and the skull to minimize earplug motion when the earplug is not inserted into the ear canal.

String-type attachment devices have several disadvantages including their dangling nature, which is distracting for the practitioner and introduces a risk of interference with moving machinery.

Other devices in the prior art are combinations of hearing and eye protection. Huhtala U.S. Pat. No. 5,541,677 is directed to a vision-hearing protection device, each embodiment including an eyeglass retainer, for holding eyeglasses on the user's head or around the neck, and earplugs connected to the retainer for protecting the user's hearing. This vision-hearing protection device includes a retraction feature wherein the earplugs may be pulled in for more secure and compact “storage” and then quickly drawn out toward the ears for convenient reinsertion. Bright U.S. Pat. No. 5,781,272 is directed to an eyesight and hearing safety apparatus that comprises a front guard portion protecting the eyesight of the human being, as well as two earpieces attached to the temple supports for hearing protection.

Sanpei U.S. Pat. No. 6,382,213 is a similar combination device that is used for the heating and sight protection. The device is supported on a person's head through contact with both ear canals and a bridge of a person's nose and is readily adjustable. Finally, Wadsworth U.S. Pat. No. 6,728,974 is directed to an eye and ear protection device providing a glasses-like eye shield with the addition of hingedly attached earplugs on the ends of the ear supports.

The prior art devices have several known drawbacks depending on the methodology employed to position and store the earplugs. The combination of an ear and eye-protection device does not allow practitioners the flexibility to interchange between different pairs or types of eye glasses, thus limiting the practitioner to those devices produced by the manufacturer. The present invention allows the practitioner to select the most suitable eye protection for their work environment. The present invention is not bound by a set type of eye protection glasses, and indeed may be freely exchanged between multiple pairs of safety glasses, eyeglasses or sunglasses, depending on the requirements or personal preferences of the practitioner.

Additionally, it is well known that ill-fitting or dangling apparel poses a severe risk in certain work environments. Such apparel may become entangled with heavy machinery, subjecting the worker to potential injury or death. In such instances, dangling effects should be avoided and are typically forbidden. Devices that provide a tether or string for retaining ear protection are both distracting to the practitioner and pose a significant catchment risk around operating machinery The present invention eliminates this risk by removing any loose or dangling articles from its design.

### SUMMARY OF THE INVENTION

In view of the foregoing disadvantages inherent in the known types of earplug attachment devices now present in the prior art, the present invention provides a new device capable of hingedly attaching earplugs to safety glasses wherein the same can be utilized for providing convenience for the user when operating in a high noise level environment.

It is therefore an object of the present invention to provide hingedly retractable earplug assembly device capable of removably securing to the temple support bar of any pair of eye or safety glasses.

Another object of the present invention is to provide hearing protection that provides a user the ability to quickly apply or remove hearing protection, and further prevent it from falling on a contaminated surface or misplacing it when not in use.

Still another aspect of the present invention is to provide simple, inexpensive, yet modular hearing protection device that can be used in a plurality of environments.

Other objects, features and advantages of the present invention will become apparent from the following detailed description taken in conjunction with the accompanying drawings.

### BRIEF DESCRIPTIONS OF THE DRAWINGS

FIG. 1 depicts a perspective view of the present invention attached to a pair of safety glasses.

FIG. 2 depicts an alternative side view of the present invention attached to a pair of safety glasses.

### DETAILED DESCRIPTION OF THE INVENTION

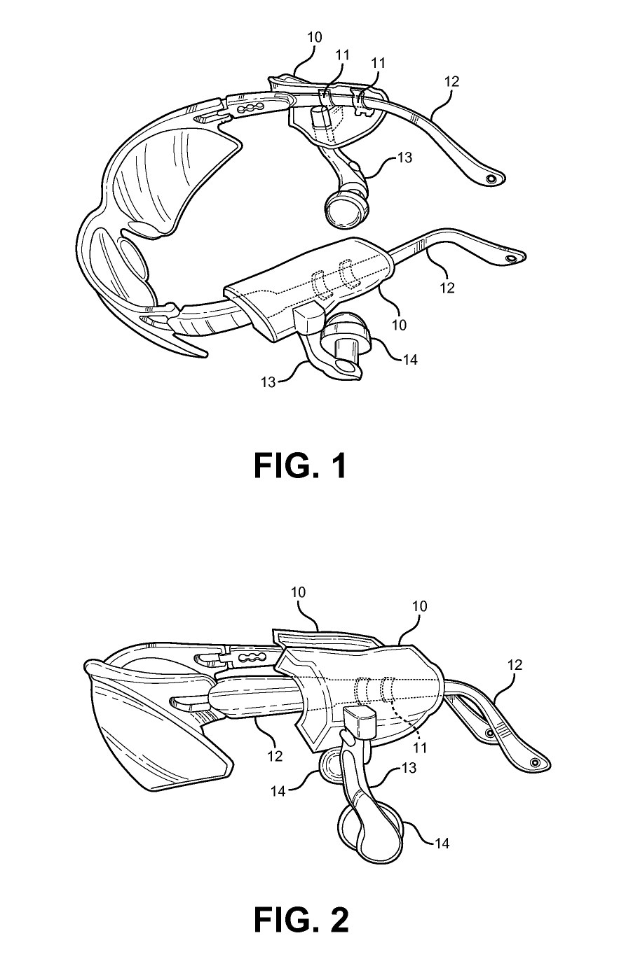

Referring now to FIG. 1, there is shown a perspective view of the present invention mounted on the temple support bars 12 of a pair of safety glasses. The present invention comprises a bracket 10 attached to a pair of eye or safety glasses by one or a plurality of clips 11, which accept and surround the temple support bar 12 of the glasses. Hingedly attached to the bracket 10 is an extension arm 13, to which an earplug 14 is further attached at its distal end. Said extension arm 13 is contoured to a form suitable for alignment of the earplug 14 with the wearer's ear. The contoured arm 13 is capable of rotating in relation to the bracket 10 to allow the earplug 14 to be withdrawn from the practitioner's ear and safely suspended for later use. The rotational joint may comprise a ball joint that provides unrestricted rotation, or a pin joint that allows rotation about a single axis.

Referring now to FIG. 2, there is shown a side view of the present invention mounted to the temple support bars of a pair of safety glasses. The present invention comprises a bracket 10, capable of attaching to any eye or safety glasses by one or a plurality of clips 11. Hearing protection 14 is provided at the distil ends of extension arms 13, which provide the user with the ability to locate the hearing protection 14 anywhere in relation to the safety glasses, including in the user's ears or stowed to the side of the glasses when not required. The extension arms 13 allow different user ear geometry to be accommodated, by rotating the arm 13 from the bracket 10, and by sliding the bracket 10 up and down the length of the temple support bars.

In use, the present invention comprises an earplug assembly that can be easily attached by sliding or clipping to the temple support bars 12 of a pair of eye or safety glasses as is shown in FIGS. 1 and 2. The bracket 10 of the device is attached using a plastic or metal clip 11, or other suitable method of attachment. The bracket 10, serving as the base of the device, may be composed of plastic, metal or a combination of these and other materials. The clips 11 may be a closed loop, in which the temple support bar would be fed concentrically therethrough, or the clip 11 may provide an open ring design to slide over and grasp a temple support bar.

Attached to the bracket 10 is a contoured attachment arm 13, which may be rigid or conformable. The arm may comprise of plastic or metal construction if rigid, or alternatively a dense foam material that provides malleability. An earplug 14 is removably attached to the distal end of the contoured extension arm 13, enabling it to be alternatively inserted into the ear, or stored against the wearer's head. When the arm 13 rotates downward, said earplugs 14 may be inserted into the wearer's ears, offering hearing protection to the practitioner. The arm 13 may then be flipped upward to disengage the ear plugs from the ears. The construction of the assembly prevents dangling articles that can result in entanglement with machinery, which is a serious injury concern in certain factory environments.

For the device as constructed in FIGS. 1 and 2, each portion may be formed of plastic, rubber, metal or any other material found suitable by one skilled in the art. The exact dimensions of the device will vary in order to allow attachment to varying sizes of eye and safety glasses. Earplugs may be attached to the device, or alternatively the practitioner may provide his or her own ear plugs for attachment to the distal ends of the extension arms. These may be earplugs any standard variety to suit a given noise level and user preference.

Thus, the invention provides an earplug attachment means for mounting on the temple support bar of any eye or safety glasses, as well as providing a way to quickly apply or stow a set of ear plugs in noisy environments. The typical earplug wearer takes the earplugs out of each ear every time he or she enters a low-noise area or needs to hear someone speak. Colocating the assembly and allowing both forms of protection to be attached to one another reduces application time, and also reduces the likelihood of lost or dropped earplugs. Likewise, the likelihood of using ear plugs is increased, as they are conveniently stored on eye protection glasses and require very little attention to locate and utilize.

Various earplug styles may be used. Although disposable, compressible foam plugs are preferred, the earplugs may be composed of any material or shape that is safe to insert into the ears and is useful for reducing the noise level. The earplugs may be integrally attached to the extension arms, or may be alternatively removably attached to the distal ends of each attachment arm.

Typical applications for the present invention include any environment with high noise levels where hearing protection is suggested or required. These may include industrial environments such as refineries, chemical plants, mills and factories. Or alternatively they may include recreational environments such as car racing events, shooting ranges, or other athletic events. The device is attachable to any type of eye glass, including protective eyewear, vision enhancing glasses or outdoor sunglasses.

In total, the present invention provides an earplug assembly that can be easily attached to any pair of eye or safety glasses, utilizing the temple support bars for support to hingedly attach a pair of ear-insertable earplugs. When not in use, the earplugs may be rotated away from the ears and stowed along the side of a wearer's head, providing convenience and improved storage. The quick application, removal and stowage of the earplugs promotes their use, improving the changes a user will employ the hearing protection in high noise level environments to prevent hearing damage or loss.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An eye glass attachable hearing protection device comprising:
a bracket with an interior and exterior surface;
one or a plurality of clips along said bracket interior surface;
said clips attaching said bracket to a temple support bar of eye or safety glasses;
an extension arm hingedly attached to said bracket exterior surface,
an earplug attached to a distal end of said extension arm,
said extension arm is rotatable relative to said bracket, allowing insertion and removal of said earplug from a practitioner's ear.

2) A device as in claim 1, wherein said clips are closed loops, accepting a temple support bar concentrically therethrough.

3) A device as in claim 1, wherein said clips are partially open loops, slideably accepting a temple support bar through said loop opening.

4) A device as in claim 1, wherein said earplug is removably and replaceably attached.

5) A device as in claim 1, wherein said extension arm hinged attachment is a ball joint, allowing free rotation from said attachment point.
